(19) United States
(12) Patent Application Publication
(10) Pub. No.: US 2008/0189967 A1
(43) Pub. Date: Aug. 14, 2008

(54) Standardizable level tool

(76) Inventor: Shinji Tosa, Glendale, CA (US)

Correspondence Address: DAVID AND RAYMOND PATENT FIRM, 108 N. YNEZ AVE., SUITE 128, MONTEREY PARK, CA, 91754, US

(21) Appl. No.: 11/704,553

(22) Filed: Feb. 9, 2007

(51) Int. Cl. G01C 9/36

(52) U.S. Cl. 33/390

(57) ABSTRACT

A level measuring tool for an object having a measuring surface includes a level housing and a measuring arrangement. The level housing has a measurement cavity and a level surface adapted for sitting on the measuring surface of the object. The measuring arrangement includes a liquid indicator received in the measurement cavity of the level housing, and a plurality of level markers spacedly provided at a peripheral side of the liquid indicator to indicate an inclination angle of the level surface of the level housing at 0°, 45°, and 90° levels respectively, wherein the liquid indicator contains a predetermined volume of liquid therein and an indicator bubble movably floating on the liquid such that the measuring arrangement is adapted for measuring a level of the measuring surface when the indicator bubble moves at one of the level markers.

### BACKGROUND OF THE PRESENT INVENTION

1. Field of Invention

The present invention relates to a measuring device, and more particularly to a compact level measuring tool which is capable of measuring discrete or continuous angle inclination (such as a horizontal orientation) of a measuring surface.

2. Description of Related Arts

A conventional level measuring device usually comprises an elongated level housing having a plurality of gauge cavities spacedly formed along a longitudinal direction of the level housing, and a corresponding number of measuring gauges mounted at the gauge cavities respectively for measuring particular inclination of the level housing. The level housing is arranged to rest on a measuring surface of which its orientation is to be measured. Each of the measuring gauges usually comprises a transparent tube filled with a predetermined amount of fluid, such as colored liquid, to form a gas bubble within the tube, wherein the gas bubble freely displaces along the tube corresponding to an orientation of the level housing. In order to further enhance the accuracy of the measurement, each of the measuring gauges further has a plurality of measurement marks formed on the transparent tube for indicating a position of the gas bubble, wherein each of the measurement marks corresponds with a particular orientation of the level housing. Thus, the measurement marks help to interpret the orientation of the level housing so as to measure an orientation of a measuring surface.

There exist several disadvantages in association with this conventional level measuring device. First, in order to measure different orientations of a measuring surface, the level measuring device has to incorporate the corresponding number of measuring gauges. For example, the transparent tubes are often orientated in such a manner to measure different angle inclinations of the level housing. Thus, when the level measuring device is designed to measure horizontal level and a 45 degree inclination, it must comprise two measuring gauges. The more orientations the level measuring device is designed to measure, the more the measuring gauges. The consequence is that the level housing must be elongated and bulky to support the measuring gauges. This makes the level measuring device difficult to carry, and inconvenient to use.

Second, many conventional level measuring devices are not durable. As a result, when they have been utilized for a certain period of time, the level measuring devices, especially the measuring gauges, may be recalibration. Virtually no conventional measuring device comprises some sorts of recalibration arrangements. As a result, when the level measuring devices need recalibration, the users have no option but to dispose the old devices and purchase new devices.

### SUMMARY OF THE PRESENT INVENTION

A main object of the present invention is to provide a level measuring tool which is compact in size, and is capable of measuring discrete or continuous angle inclination of a measuring surface by a single liquid indicator. In other words, there is no need to utilize a plurality of measuring gauges as in the case of conventional level measuring devices.

Another object of the present invention is to provide a level measuring tool which comprises a liquid indicator having a plurality of level markers for accurately indicating an inclination angle of a level surface at 0°, 45°, or 90°.

Another object of the present invention is to provide a level measuring tool which is capable of recalibrating so as to ensure accurate measurement of inclination angles, even after a prolonged period of use.

Another object of the present invention is to provide a level measuring tool which is compact in size when compared to conventional level measuring devices, so that the present invention is easy to carry, convenient to use, and is suitable for use in a wide variety of environments, especially in confined spaces.

Another object of the present invention is to provide a level measuring tool which does not include complicated or expensive mechanical or electrical components, so as to minimize the manufacturing cost of the present invention.

Accordingly, in order to accomplish the above objects, the present invention provides a level measuring tool for an object having a measuring surface, comprising:

a level housing having a measurement cavity and a level surface adapted for sitting on the measuring surface of the object; and

a measuring arrangement comprising a liquid indicator received in the measurement cavity of the level housing and a plurality of level markers spacedly provided at a peripheral side of the liquid indicator to accurately indicate an inclination angle of the level surface of the level housing at 0°, 45°, and 90° levels respectively, wherein the liquid indicator contains a predetermined volume of liquid therein and an indicator bubble movably floating on the liquid such that the measuring arrangement is adapted for measuring a level of the measuring surface when the indicator bubble moves at one of the level markers to ensure the measuring surface of the object at the respective level.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a level measuring tool according to a preferred embodiment of the present invention.

FIG. 2 is an exploded perspective view of the level measuring tool according to the above preferred embodiment of the present invention.

FIG. 3 is a schematic diagram of the level measuring tool according to the above preferred embodiment of the present invention.

FIG. 4 is schematic diagrams of the first alternative mode of the level measuring tool according to the above preferred embodiment of the present invention.

FIG. 5A and FIG. 5B are schematic diagrams of a second alternative mode of the level measuring tool according to the above preferred embodiment of the present invention.

FIG. 6A and FIG. 6B are schematic diagrams of a third alternative mode of the level measuring tool according to the above preferred embodiment of the present invention.

FIG. 7 illustrates a modification of the locking device as a calibration arrangement according to the above preferred embodiment of the present invention.

### DETAILED DESCRIPTION OF THE PREFERRED EMBODIMENT

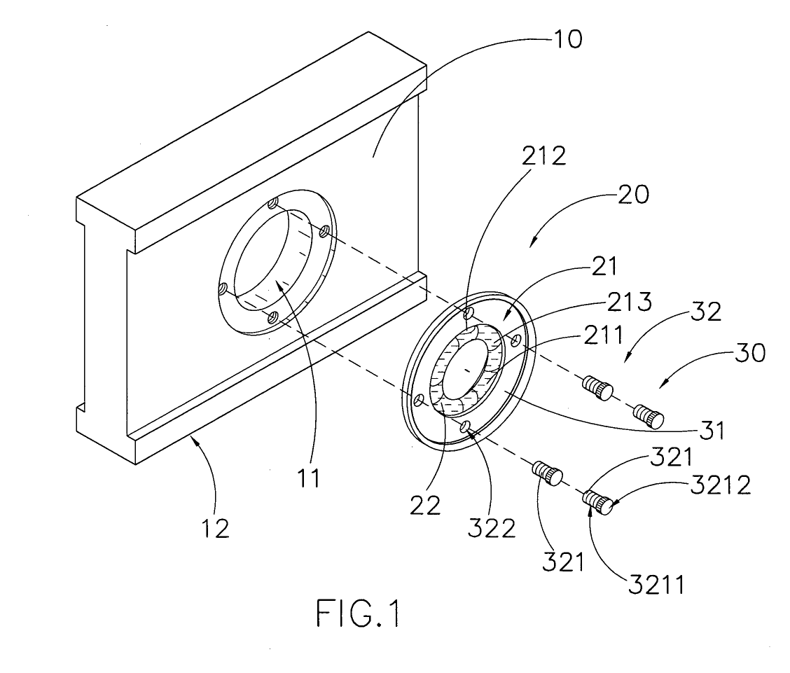

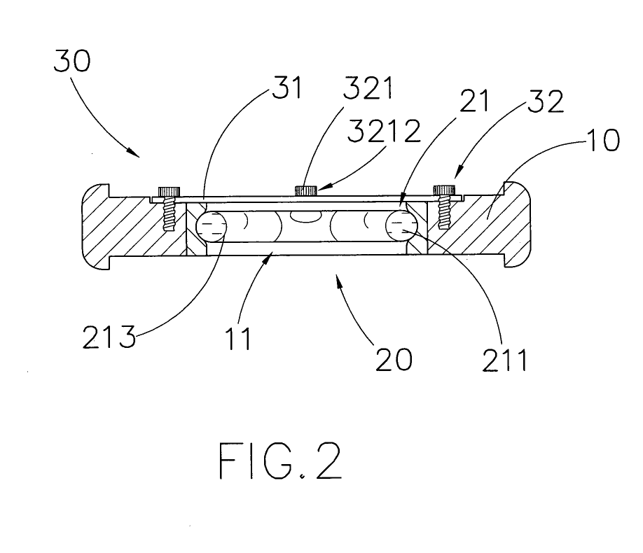

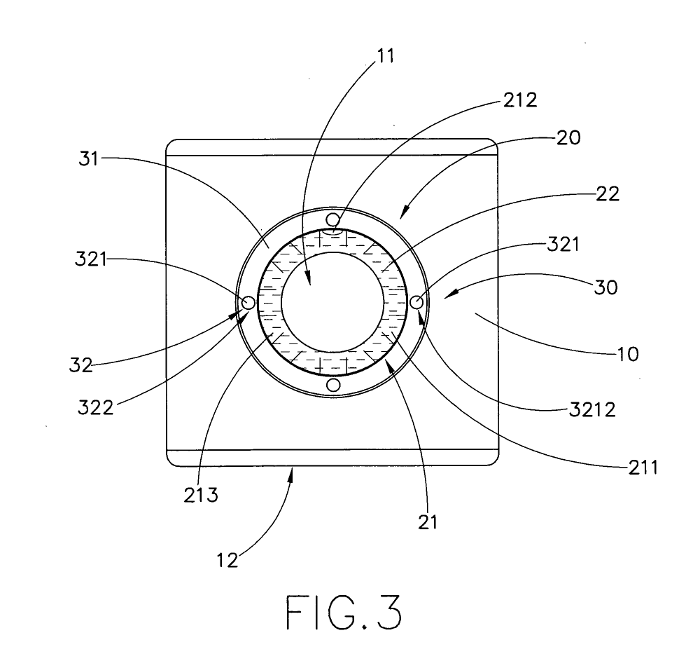

Referring to FIG. 1 to FIG. 3 of the drawings, a level measuring tool according to a preferred embodiment of the present invention is illustrated, in which the level measuring tool is for an object having a measuring surface, and comprises a level housing 10, and a measuring arrangement 20. The level housing 10 has a measurement cavity 11 and a level surface 12 adapted for sitting on the measuring surface of the object.

The measuring arrangement 20 comprises a liquid indicator 21 received in the measurement cavity 11 of the level housing 10, and a plurality of level markers 22 spacedly provided at a peripheral side of the liquid indicator 21 to accurately indicate an inclination angle of the level surface 12 of the level housing 10 at either 0°, 45°, or 90° levels respectively, wherein the liquid indicator 21 contains a predetermined volume of liquid 211 therein and an indicator bubble 212 movably floating on the liquid 211 such that the measuring arrangement 20 is adapted for measuring a level of the measuring surface when the indicator bubble 212 moves at one of the level markers 22 to ensure the measuring surface of the object at the respective level.

According to the preferred embodiment of the present invention, the level housing 10 has a rectangular cross section with the level surface 12 formed as a bottom surface of the level housing 10. The measurement cavity 11 is formed on a central portion of the level housing 10 wherein the liquid indicator 21 is securely mounted at the measurement cavity 11 such that a user can observe a result of measurement from an exterior of the level housing 10 through the measurement cavity 11. Thus, the level surface 12 of the level housing 10 is adapted to align and rest on the measuring surface of the object so as to allow the liquid indicator 21 to indicate a level or an angle of inclination of the measuring surface.

The liquid indicator 21 comprises a transparent measurement tube 213 extended at the measurement cavity 11 to form an endless circular loop therewithin, wherein the liquid 211 is filled into the transparent measurement tube 213 for forming the movable indicator bubble 212 in the transparent measurement tube 213. It is worth mentioning that in order to enhance the performance of indicating levels, the liquid 211 is dyed to have a predetermined color, such as fluorescent green, for optimally and visually displaying the indicator bubble 212 within the transparent measurement tube 213.

The plurality of level markers 22 are formed around the transparent measurement tube 213 on the level housing 10, wherein each of the level markers 22 correspond an angle of inclination to which the level surface 12 orients according to the orientation of the measuring surface of the object. For example, the level markers 22 may discretely contain the angle of inclinations of 0°, 45°, or 90° to indicate the angle of inclination of the measuring surface.

Thus, when the level housing 10 is placed on the measuring surface of the object, the level surface 12 of the level housing 10 aligns with the measuring surface. The indicator bubble 212 will then move along the transparent measurement tube 213 to stop at a position which is the highest point of the transparent measurement tube 213. If the position of the indicator bubble 212 matches with any of the level markers 22, that corresponding level marker 22 reads the angle of inclination of the measuring surface of the object. For example, when the indicator bubble 212 moves to a position where it matches with a “45°” mark, it is an indication that the measuring surface has an angle of inclination of 45°. Similarly, when the indicator bubble 212 moves to a position where it matches with a “0°” mark, it is an indication that the measuring surface is horizontal.

It is worth mentioning that the level markers 22 are spacedly formed on an outer side of the measurement tube 213, wherein each of the level markers 22 contains two spaced apart marker lines formed on the measurement tube 213 such that when the indicator bubble 212 is moved within the measurement tube 213 at a position between the two marker lines, the level surface 12 of the level housing 10 is supported at the respective level marker 22.

In addition, the level measuring tool further comprises a locking means 30 for locking the measuring arrangement 20 at the measurement cavity 11 of the level housing 10. The locking means 30 comprises a ring shaped member 31 which is coaxially mounted around the liquid indicator 21 and a plurality of screw lockers 321 penetrating the ring-shaped member 31. Accordingly, a plurality of through holes 322 are spacedly formed on the ring shaped manner 31, wherein the end of each of the two screw lockers 321 are locked at the level housing 10 through the respective through hole 322 to lock up the measuring arrangement 20 at the measurement cavity 11 of the level housing 10. It is worth mentioning that the measuring arrangement 20 can be integrally formed at the measurement cavity 11 of the level housing 10 to form a one-piece structure without the locking means 30.

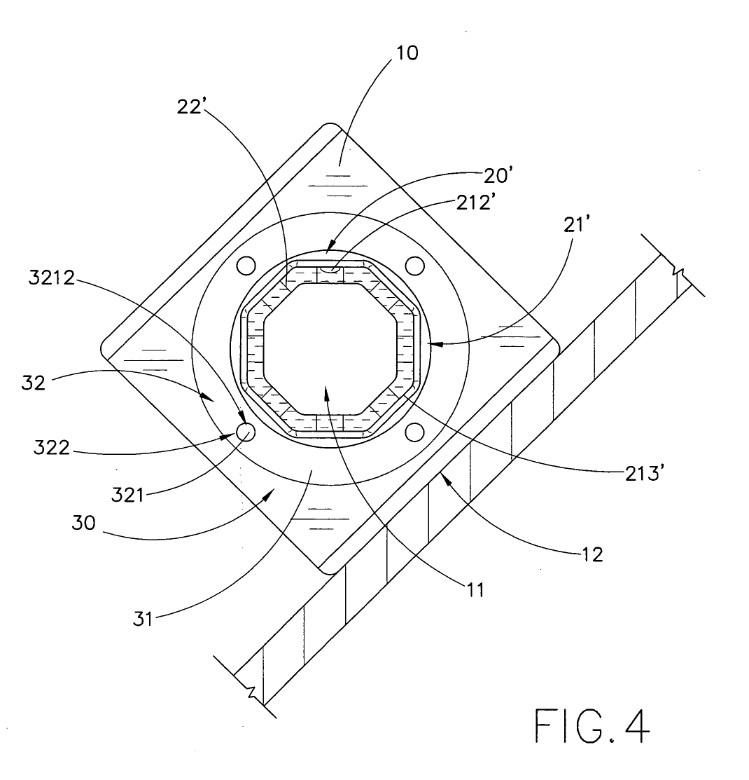

Referring to FIG. 4 of the drawings, a first alternative mode of the level measuring tool according to the preferred embodiment of the present invention is illustrated. The first alternative mode is similar to the preferred embodiment except the liquid indicator 21′ of the measuring arrangement 20′. According to the first alternative mode, the transparent measurement tube 213′ of the liquid indicator 21′ forms a polygonal loop having a predetermined polygonal shape for measuring the angle of inclination of the level housing 10 as shown by the level markers 22′ via the liquid 211′ and the indicator bubble 212′. As shown in FIG. 4 of the drawings, the transparent measurement tube 213′ forms an octagonal cross sectional shape for measuring the angle of inclination.

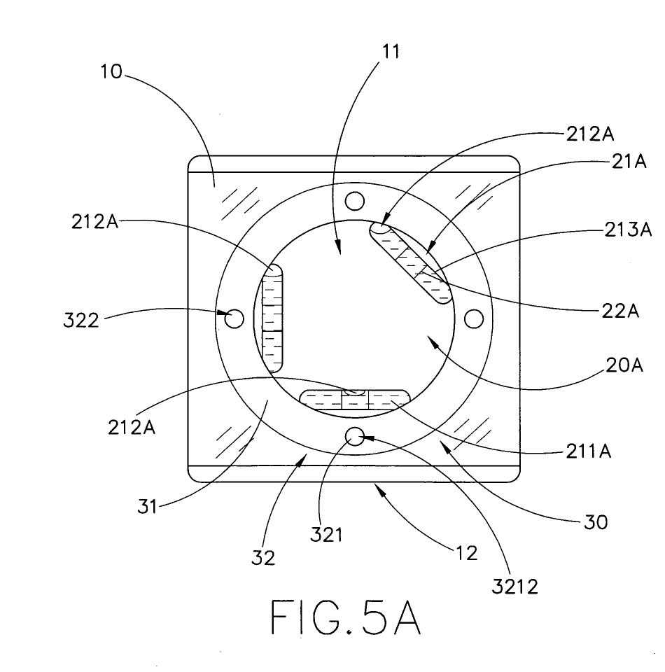

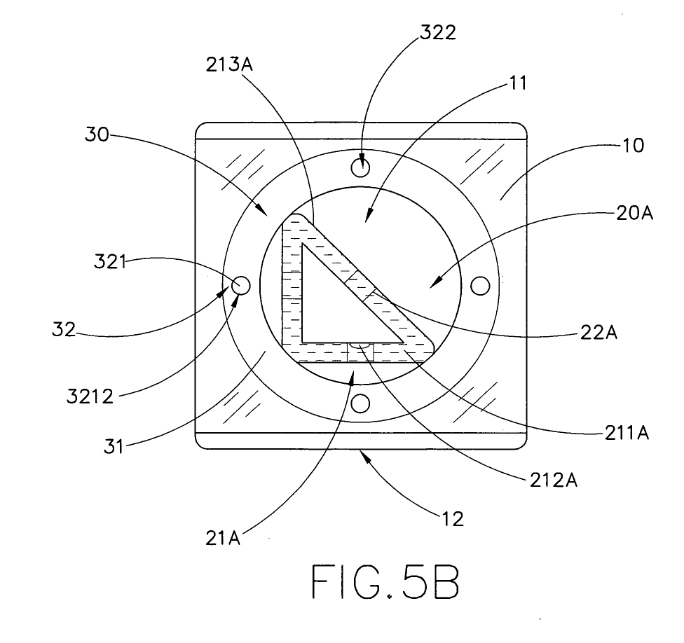

Referring to FIG. 5A to FIG. 5B of the drawings, a second alternative mode of the level measuring tool according to the preferred embodiment of the present invention is illustrated. The second alternative mode is similar to the preferred embodiment except the liquid indicator 21A of the measuring arrangement 20A. According to the second alternative mode, the liquid indicator 21A comprises a plurality of transparent measurement tubes 213A spacedly supported at the measurement cavity 11 that at a position that each of the measurement tubes 213A represents the inclination angle of the level surface 12 at the respective level, wherein the liquid 211A is filled into each of the measurement tubes 213A that the indicator bubble 212A is moved within the respective measurement tube 213A to align with one of the level markers 22A. As shown in FIG. 5A of the drawings, the transparent measurement tubes 213A form a quadrilateral cross section, while FIG. 5B illustrate that the transparent measurement tubes 213A form a triangular cross section.

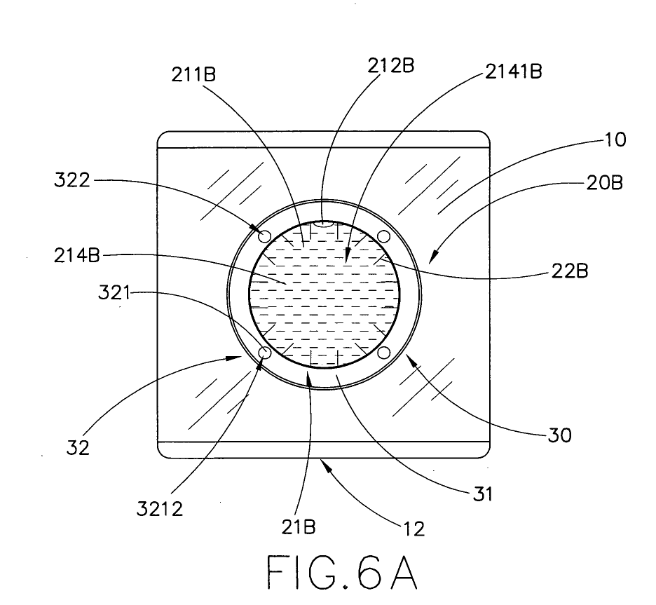

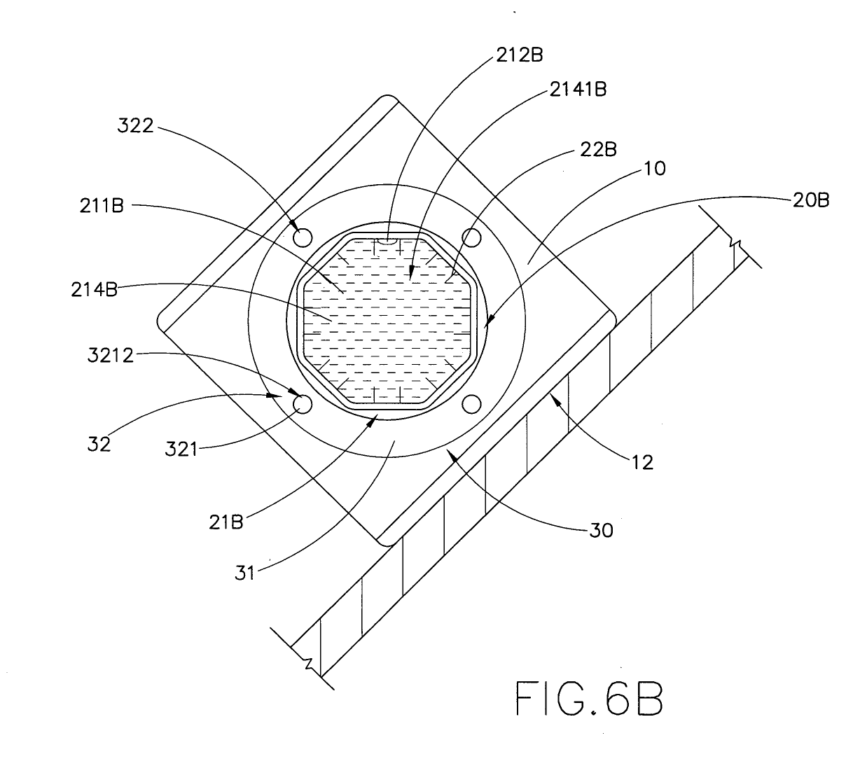

Referring to FIG. 6A to FIG. 6B of the drawings, a third alternative mode of the level measuring tool according to the preferred embodiment of the present invention is illustrated. The third alternative mode is similar to the preferred embodiment except the liquid indicator 21B of the measuring arrangement 20B. According to the third preferred embodiment, the liquid indicator 21B comprises a transparent hollow indicator member 214B, having a liquid storage cavity 2141B, filled with the liquid 211B that the indicator bubble 212B is moved within the liquid storage cavity 2141B of the indicator member 214B to align with one of the level markers 22B.

The level markers 22B are spacedly formed on an edge portion of the hollow indicator member 214B, wherein each of the level markers 22B contains two spaced apart marker lines formed on the hollow indicator member 214B such that when the indicator bubble 212B is moved within the liquid storage cavity 2141B at a position between the two marker lines, the level surface 12B of the level housing 10 is supported at the respective level marker 22B. The indicator bubble 212B is arranged to travel along a peripheral rim portion of the transparent indicator member 214B so that a user is able to read the angle of inclination of the level housing 10 from the relevant level markers 22B provided thereon.

It is worth mentioning that the hollow indicator member 214B may form a circular cross section, as shown in FIG. 6A of the drawings. Alternatively, the hollow indicator member 214B may form a polygonal cross section, such as an octagonal cross section, as shown in FIG. 6B of the drawings.

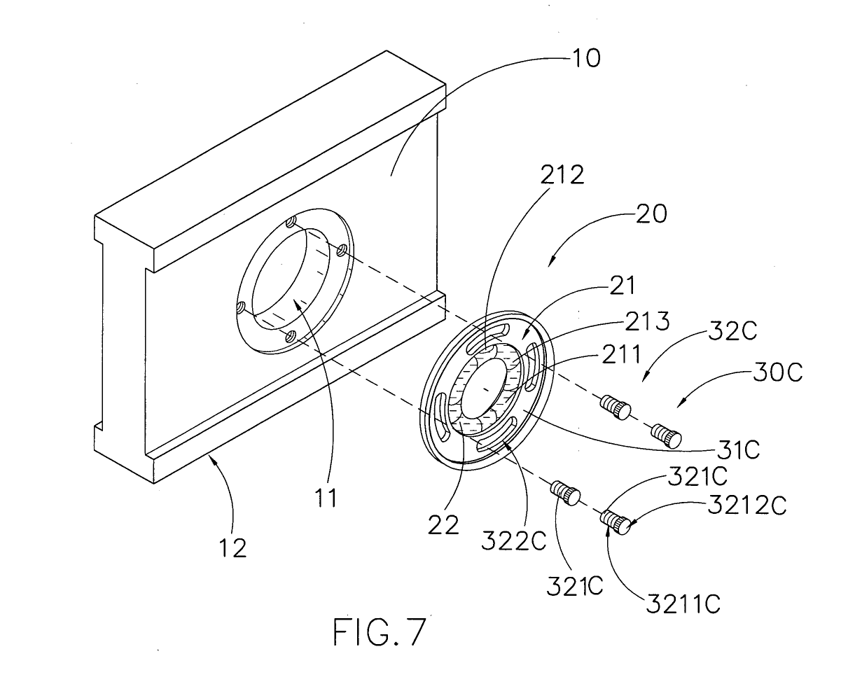

FIG. 7 illustrates a modification of the locking means 30 of the above preferred embodiment of the present invention, wherein the locking means 30 is modified to form a calibration arrangement 30C.

Since the level markers 22 are conventionally designated to indicate the angle of inclination of the measuring surface. The measuring arrangement 20C may further contain a plurality of enhancement markers 23 formed on the liquid indicator 21 enhancing a position recognition of the indicator bubble 212 of the measuring arrangement 20, and to recognize the circumstances in which recalibration is required. For example, if the user is confident that the level housing 10 is placed on a horizontal measuring surface, but if the indicator bubble 212 does not displace to the right position, i.e. a position which does not match with a “0°” level marker 22, then the user will know that recalibration of the level measuring tool is needed.

In order to facilitate the recalibration mechanism of the present invention, the level measuring tool further comprises a calibration arrangement 30C for calibrating the level markers 22 with respect to a reference surface, wherein the calibration arrangement 30C comprises a ring shaped calibrating member 31C which is coaxially mounted around the liquid indicator 21 and is rotatably mounted on the level housing 10 to drive the liquid indicator 21 to rotate with respect to the level housing 10 within the measurement cavity 11 thereof, such that when the level surface of the level housing 10 is sat on the reference surface, the calibrating member 31C is adjustably rotated until the corresponding level marker 22 is aligned with the indicator bubble 212 so as to calibrate the measuring arrangement 30C with respect to the level surface 12 of the level housing 10.

According to the preferred embodiment of the present invention, the liquid indicator 21 is attached to an inner side of the calibrating member 31C such that when the calibrating member 31C is driven to rotate, the liquid indicator 21 is correspondingly turned to align the indicator bubble 212 with the respective level marker 22 with respect to the reference surface.

Moreover, the calibrating arrangement 30C further comprises a locking device 32C coupled with the calibrating member 31C to allow the calibrating member 31C to selectively operate between a normal measurement mode and a calibration mode, wherein in the normal measurement mode, the locking device 32C is arranged to lock up a rotational movement of the calibrating member 31C so as to normally display the accurate angle of inclination of the level surface 12 of the level housing 10 by the level markers 22, wherein in the calibration mode, the locking device 32C unlocks the calibrating member 31C to allow free rotation of the calibrating member 31C with respect to the indicator bubble 212 for calibration.

As a result, the locking device 32C contains at least a curved slot 322C formed on an outer side of the calibrating member 31C and comprises at least a screw locker 321C having an elongated locking body 3211C slidably passing through the curved slot 322C and an enlarged locking head 3212C arranged when the locking body 3211C is attached to the level housing 10, the locking head 3212C is pressed on the outer side of the calibrating member 31C to lock up the calibrating member 31C at the level housing 10. Thus, when the user is sure that the level housing 10 is placed on a substantially horizontal measuring surface, but the indicator bubble 212 nevertheless displaces to a position which corresponds to level marker 22 other than the “0°” level mark, the user will know that a recalibration of the level measuring tool is required.

According to the preferred embodiment of the present invention, the locking device 32C comprises a plurality of screw lockers 321C penetrating the calibrating member 31C. On the other hand, the level housing 10 has at least two curved slots 322C spacedly formed on the level housing 10 along a side rim portion of the measurement cavity 11, wherein two ends of the two screw lockers 321C are slidably engaged with the curved slots 322C respectively to selectively lock up with the level housing 10 so as to selectively operate the calibrating member 31C between the normal measurement mode and the calibration mode.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1-25. (canceled)

26. A level measuring tool for an object having a measuring surface, comprising:
a level housing having a measurement cavity and a level surface adapted for sitting on said measuring surface of said object;
a measuring arrangement comprising a liquid indicator received in said measurement cavity of said level housing and at least one level marker provided at a peripheral side of said liquid indicator to accurately indicate an inclination angle of said level surface of said level housing at 0° level, wherein said liquid indicator contains a predetermined volume of liquid therein and an indicator bubble movably floating on said liquid such that said measuring arrangement is adapted for measuring a level of said measuring surface when said indicator bubble moves at said level marker to ensure said measuring surface of said object at said 0° level, wherein said liquid indicator comprises an elongated transparent measurement tube extended at said measurement cavity to form a loop therewithin, wherein said liquid is filled into said measurement tube that said indicator bubble is moved within said measurement tube to align with one of said level markers; and
a calibration arrangement provided on said level housing for calibrating said level markers with respect to a reference surface, wherein said calibration arrangement comprises a calibrating member coaxially mounted around said liquid indicator and is movably mounted on said level housing to drive said liquid indicator to move with respect to said level housing within said measurement cavity thereof, such that when said level surface of said level housing is sat on the reference surface, said calibrating member is adjustably moved until said corresponding level marker is aligned with said indicator bubble so as to conveniently and accurately calibrate said measuring arrangement with respect to said level surface of said level housing.

27. The level measuring tool, as recited in claim 26, wherein said measuring arrangement further comprises a 90° level marker provided at a peripheral side of said liquid indicator to accurately indicate an inclination angle of 90° of said level surface of said level housing.

28. The level measuring tool, as recited in claim 27, wherein said measuring arrangement further comprises an acute angle level marker provided at a peripheral side of said liquid indicator at a position between said 0° level and said 90° level to accurately indicate an inclination angle which is an acute angle for said level surface of said level housing.

29. The level measuring tool, as recited in claim 28, wherein said measuring arrangement further comprises an acute angle level marker is a 45° level marker provided at said peripheral side of said liquid indicator to accurately indicate a 45° inclination angle of said level surface of said level housing.

30. The level measuring tool, as recited in claim 29, wherein said measurement tube is configured in a circular shape.

31. The level measuring tool, as recited in claim 29, wherein said measurement tube is configured in a polygon shape.

32. The level measuring tool, as recited in claim 30, wherein said level markers are spacedly formed on an outer side of said measurement, tube, wherein each of said level markers contains two spaced apart marker lines formed on said measurement tube such that when said indicator bubble is moved within said measurement tube at a position between said two marker lines, said level surface of said level housing is supported at said respective level marker.

33. The level measuring tool, as recited in claim 31, wherein said level markers are spacedly formed on an outer side of said measurement tube, wherein each of said level markers contains two spaced apart marker lines formed on said measurement tube such that when said indicator bubble is moved within said measurement tube at a position between said two marker lines, said level surface of said level housing is supported at said respective level marker.

34. The level measuring tool, as recited in claim 26, wherein said liquid indicator comprises a plurality of transparent measurement tubes spacedly supported at said measurement cavity that at a position that each of said measurement tubes represents said inclination angle of said level surface at said respective level, wherein said liquid is filled into each of said measurement tubes that said indicator bubble is moved within said respective measurement tube to align with one of said level markers, wherein said transparent measurement tubes form a loop for measuring level at different orientations.

35. The level measuring tool, as recited in claim 34, wherein said measuring arrangement further comprises a 90° level marker provided at a peripheral side of said liquid indicator to accurately indicate an inclination angle of 90° of said level surface of said level housing.

36. The level measuring tool, as recited in claim 35, wherein said measuring arrangement further comprises an acute angle level marker provided at a peripheral side of said liquid indicator at a position between said 0° level and said 90° level to accurately indicate an inclination angle which is an acute angle for said level surface of said level housing.

37. The level measuring tool, as recited in claim 36, wherein said measuring arrangement further comprises an acute angle level marker as a 45° level marker provided at said peripheral side of said liquid indicator to accurately indicate a 45° inclination angle of said level surface of said level housing.

38. The level measuring tool, as recited in claim 37, wherein said measurement tubes are configured in a polygon shape.

39. The level measuring tool, as recited in claim 38, wherein said level markers are spacedly formed on an outer side of each of said measurement tubes, wherein each of said level markers contains two spaced apart marker lines formed on said measurement tube such that when said indicator bubble is moved within said respective measurement tube at a position between said two marker lines, said level surface of said level housing is supported at said respective level marker.

40. A level measuring tool for an object having a measuring surface, comprising:
a level housing having a measurement cavity and a level surface adapted for sitting on said measuring surface of said object; and
a measuring arrangement comprising a liquid indicator received in said measurement cavity of said level housing and at least one level marker provided at a peripheral side of said liquid indicator to accurately indicate an inclination angle of said level surface of said level housing at 0° level, wherein said liquid indicator contains a predetermined volume of liquid therein and an indicator bubble movably floating on said liquid such that said measuring arrangement is adapted for measuring a level of said measuring surface when said indicator bubble moves at said level marker to ensure said measuring surface of said object at said 0° level, wherein said liquid indicator comprises a transparent hollow indicator member with a uniform cross section, having a liquid storage cavity, filled with said liquid that said indicator bubble is moved within said liquid storage cavity of said indicator member to align with one of said level markers.

41. The level measuring tool, as recited in claim 40, wherein said measuring arrangement further comprises a 90° level marker provided at a peripheral side of said liquid indicator to accurately indicate an inclination angle of 90° of said level surface of said level housing.

42. The level measuring tool, as recited in claim 41, wherein said measuring arrangement further comprises an acute angle level marker provided at a peripheral side of said liquid indicator at a position between the 0° level and the 90° level to accurately indicate an inclination angle which is an acute angle for said level surface of said level housing.

43. The level measuring tool, as recited in claim 42, wherein said measuring arrangement further comprises an acute angle level marker is a 45° level marker provided at said peripheral side of said liquid indicator to accurately indicate a 45° inclination angle of said level surface of said level housing.

44. The level measuring tool, as recited in claim 43, wherein said hollow indicator member is configured in a circular shape.

45. The level measuring tool, as recited in claim 43, wherein said hollow indicator member is configured in a polygon shape.

46. The level measuring tool, as recited in claim 44, wherein said level markers are spacedly formed on an edge portion of said hollow indicator member wherein each of said level markers contains two spaced apart marker lines formed on said hollow indicator member such that when said indicator bubble is moved within said liquid storage cavity at a position between said two marker lines, said level surface of said level housing is supported at said respective level marker.

47. The level measuring tool, as recited in claim 45, wherein said level markers are spacedly formed on an edge portion of said hollow indicator member wherein each of said level markers contains two spaced apart marker lines formed on said hollow indicator member such that when said indicator bubble is moved within said liquid storage cavity at a position between said two marker lines, said level surface of said level housing is supported at said respective level marker.

48. The level measuring tool, as recited in claim 46, further comprising a calibration arrangement provided on said level housing for calibrating said level markers with respect to a reference surface, wherein said calibration arrangement comprises a calibrating member coaxially mounted around said liquid indicator and is movably mounted on said level housing to drive said liquid indicator to move with respect to said level housing within said measurement cavity thereof, such that when said level surface of said level housing is sat on the reference surface, said calibrating member is adjustably moved until said corresponding level marker is aligned with said indicator bubble so as to conveniently and accurately calibrate said measuring arrangement with respect to said level surface of said level housing.

49. The level measuring tool, as recited in claim 47, further comprising a calibration arrangement provided on said level housing for calibrating said level markers with respect to a reference surface, wherein said calibration arrangement comprises a calibrating member coaxially mounted around said liquid indicator and is movably mounted on said level housing to drive said liquid indicator to move with respect to said level housing within said measurement cavity thereof, such that when said level surface of said level housing is sat on the reference surface, said calibrating member is adjustably moved until said corresponding level marker is aligned with said indicator bubble so as to conveniently and accurately calibrate said measuring arrangement with respect to said level surface of said level housing.
